(19) United States
(12) Patent Application Publication
(10) Pub. No.: US 2017/0064987 A1
(43) Pub. Date: Mar. 9, 2017

(54) MIXTURES AND COMPOSITIONS FOR TREATING FOOD PRODUCTS

(71) Applicant: WTI, Inc., Jefferson, GA (US)

(72) Inventors: Ertan Ergyunov Hyuseinov, Jefferson, GA (US); Wolfgang Peter Ludwig, Jefferson, GA (US)

(21) Appl. No.: 15/255,762

(22) Filed: Sep. 2, 2016

Related U.S. Application Data
(60) Provisional application No. 62/214,488, filed on Sep. 4, 2015.

(51) Int. Cl. A23L 13/40; A23B 4/20; A23B 4/12; A23B 4/10; A23L 13/70; A23L 13/00

(52) U.S. Cl. CPC A23L 13/426; A23L 13/72; A23L 13/03; A23L 13/428; A23B 4/12; A23B 4/10; A23B 4/20; A23V 2002/00

(57) ABSTRACT

Mixtures and liquid compositions containing the mixtures are provided for treating a food product, especially a meat product. The mixtures can include a soluble fiber and an insoluble fiber, optionally including an ascorbic acid source. The soluble fiber can be a psyllium husk. The insoluble fiber can be a citrus fiber. The ascorbic acid source can be any source high in ascorbic acid, e.g. a citrus juice powder. Methods of treating a food product using the mixtures and liquid compositions are also provided. Treated food products are further provided. The treated food product can be a beef, poultry, pork, fish, or a combination thereof The food product can include an effective amount of the mixture or liquid composition to increase the shelf life of the food product, e.g. by increasing the water holding capacity of the food product and/or decreasing the discoloration of the food product.

### CROSS-REFERENCE TO RELATED APPLICATIONS

This application claims priority to, and the benefit of, co-pending U.S. provisional application entitled “MIXTURES AND COMPOSITIONS FOR TREATING FOOD PRODUCTS” having Ser. No. 62/214,488, filed Sep. 4, 2015, the contents of which are incorporated by reference in their entirety.

### FIELD OF THE DISCLOSURE

The disclosure is generally in the field of processed foods and methods of preparation thereof.

### BACKGROUND OF THE DISCLOSURE

Increasing consumer demand for fresh-like foods has promoted the development of alternative methods for food preservation. Microorganisms are the main agents responsible for food spoilage and food poisoning and therefore food preservation procedures have been largely targeted towards them. However, fresh cut meats are subject to rapid water loss and color deterioration, making them less palatable for most consumers although the meats may still be safe and sufficiently free of pathogenic microorganisms. Conventional meat products, especially when pre-packaged, require an environment of relatively high humidity in order to preserve a good color appearance. This is because poor water retention can lead to surface drying and browning or darkening of the exposed surfaces. The poor water retention and spoilage can also lead to deterioration of the texture or the odor of the meat product. On the other hand, exposure to elevated moisture can enhance the opportunity for microorganisms to multiply rapidly, thereby increasing the danger of spoilage. There remains a need for improved methods and compositions for retaining the texture, color, and/or odor of food products, especially ready-to-eat food products.

It is therefore an object of this disclosure to provide solutions to some of the aforementioned deficiencies in processed food products and methods of preparation thereof.

### SUMMARY

In various aspects, dry mixtures for treating a food product are provided. The mixtures can contain a soluble fiber and an insoluble fiber. The soluble fiber can be present in an amount from about 20% to 60% (w/w) based upon the weight of the mixture. Although the amount of insoluble fiber used may depend on the application, in various aspects the insoluble fiber can be present in an amount from about 30% to 80% (w/w) based upon the weight of the mixture. The mixture can also contain an ascorbic acid source. In various aspects, the ascorbic acid source can be present in an amount from about 1% to 30% (w/w) based upon the weight of the mixture. In some embodiments the mixture can contain only the soluble fiber and the insoluble fiber and only other components that do not alter the food-enhancing properties of the mixture of the soluble fiber and insoluble fiber. In some embodiments the mixture contains only the soluble fiber, the insoluble fiber, the ascorbic acid source, and only other components that do not alter the food-enhancing properties of the mixture of the soluble fiber, the insoluble fiber and the ascorbic acid source. The mixture can have a strong water binding capacity. For example the mixture can have a water binding capacity of about 5 grams to 15 grams of water per gram of mixture.

In various aspects, the mixture can contain a soluble fiber. The soluble fiber can be psyllium husk, flax seed, xanthan gum, a pectin, or a combination thereof. In various aspects, the mixture can contain an insoluble fiber. The insoluble fiber can be a citrus fiber, almond fiber, a cellulose, chia fiber, coconut fiber, corn fiber, cottonseed fiber, grape seed fiber, hemicelluloses, a lignin, oat fiber, rice hulls, safflower fiber, sesame fiber, soybean fiber, sunflower fiber, walnut fiber, or a combination thereof The citrus fiber can be obtained from a citrus fruit such as an orange, a tangerine, a lime, a lemon, a grapefruit, or a combination thereof. In some embodiments the soluble fiber is psyllium husk and the insoluble fiber is a citrus fiber. The ascorbic acid source can be a citrus juice powder, for example an orange juice powder, a tangerine juice powder, a lime juice powder, a lemon juice powder, a grapefruit juice powder, or a combination thereof The ascorbic acid source can be a non-citrus source such as chili powder, red bell pepper powder, green bell pepper powder, kale powder, broccoli powder, papaya powder, strawberry powder, cauliflower powder, pineapple powder, kiwi powder, mango powder, acerola juice concentrate or powder, kakadu plum juice concentrate or powder, camu camu powder, or a combination thereof.

In various aspects, liquid compositions for treating a food product are provided. The liquid compositions can contain an effective amount of the mixtures provided herein and a suitable solvent. The solvent can be an edible liquid such as water, a water-based liquid, a water miscible liquid, or a combination thereof The liquid composition can contain about 5% (w/w) or less of the mixture based upon the weight of the composition. The effective amount can be effective to provide the food product with at least 3% water retention for a period of at least 24 hours when applied to the food product. The effective amount can be effective to provide the food product with at least 3% water retention upon cooking when applied to the food product prior to cooking. The effective amount can be effective to provide the food product with at least 80% color retention for a period of at least one week under standard storage conditions when applied to the food product prior to storage.

In various aspects, methods of treating a food product are also provided. The methods can include the step of applying an effective amount of any one of the mixtures or the liquid compositions provided herein to the food product. The food product can be a ready-to-eat food product such as beef, poultry, pork, fish, or a combination thereof The effective amount can be effective to provide the food product with at least 3% water retention for a period of at least 24 hours when applied to the food product. The effective amount can be effective to provide the food product with at least 3% water retention upon cooking when applied to the food product prior to cooking. The effective amount can be effective to provide the food product with at least 80% color retention for a period of at least one week under standard storage conditions when applied to the food product prior to storage. In some embodiments the food product is a ground meat product and the mixture or liquid composition is mixed with the food product. In some embodiments the liquid composition is injected into the food product or is vacuum tumbled with the food product.

The mixture and/or the liquid composition can be added to a variety of food products. The food product can be a ready-to-eat food product such as beef, poultry, pork, fish, or a combination thereof The food product can contain an effective amount of any one of the mixtures provided herein. Food products can be ready to eat food products. The food products can be beef, poultry, pork, fish, or a combination thereof.

The food product can have at least 3% water retention for a period of at least 24 hours. The food product can have at least 3% water retention upon cooking. The food product can have at least 80% color retention for a period of at least one week under standard storage conditions.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### DETAILED DESCRIPTION

Described below are various embodiments of the present disclosure. Although particular embodiments are described, those embodiments are mere exemplary implementations of the system and method. One skilled in the art will recognize other embodiments are possible. All such embodiments are intended to fall within the scope of this disclosure. Moreover, all references cited herein are intended to be and are hereby incorporated by reference into this disclosure as if fully set forth herein. While the disclosure will now be described, there is no intent to limit it to the embodiment or embodiments disclosed herein. On the contrary, the intent is to cover all alternatives, modifications and equivalents included within the spirit and scope of the disclosure.

### I. Discussion

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible

Embodiments of the present disclosure will employ, unless otherwise indicated, techniques of chemistry, synthetic inorganic chemistry, analytical chemistry, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in psi. Standard temperature and pressure are defined as 0° C. and 1 bar.

It is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### II. Definitions

Unless defined otherwise, all technical and scientific terms used herein have the same meaning as commonly understood by one of ordinary skill in the art to which this disclosure pertains.

The term “food products”, as used herein, is to be understood in a broad sense and includes meat products, fish products, dairy products, beverage products, baking products, unpasteurized food products, salads, and sauces, marinades, salsas and seasonings. In some embodiments, the food product contains one or more meat products such as beef, pork, poultry, or fish. The food products can be ready-to-eat food products. The term “ready-to-eat” means the food product is distributed to be consumed without further preparation by the consumer or distributed to not require cooking or preparation to achieve food safety prior to consumption.

The term “meat product”, as used herein, includes any food product that primarily contains animal tissue, e.g. contains at least 70%, at least 80%, at least 90%, or at least 95% animal tissue including, but not limited to, beef, pork, poultry, and fish. Other animal tissues can include the tissue of many ungulates that can be used for human consumption such as deer, oxen, antelope, sheep, and goat. The term “meat product” as used herein encompasses processed meats (such as sausages, hamburgers, luncheon meats and cold cuts) and pre-prepared meat dishes such as meat pies, fish pies, game pies, stews, lasagnas and other meat-containing pasta dishes, chicken kiev, chicken cordon-bleu, chicken-a-la-king, meat rolls, meatloaf, pates, sushi, sashimi, salmon mousses, fishcakes, stir-fries etc.

The term “ready-to-eat food product” should include any food product, which is distributed to be consumed without further preparation by the consumer or distributed to not require cooking prior to consumption. The term “ready-to-eat meat product” should include any meat product, which is distributed to be consumed without further preparation by the consumer or distributed to not require cooking prior to consumption. Ready-to-eat meat products include, but are not limited to, pates, hot dogs, bologna, ham, salami, sausages, deli meats, cold cuts, and dried or cured meat products. Ready-to-eat meat products can include ready-to-eat beef products, ready-to-eat pork products, ready-to-eat poultry products, and ready-to-eat fish products.

The term “beef product”, as used herein, refers to any food that primarily contains cow tissue, e.g. contains at least 70%, at least 80%, at least 90%, or at least 95% cow tissue. The term “cow” refers to any animal of the genus Bos, such as for example the Bos Taurus, which is used as a food source for human consumption. Exemplary cow breeds used as commercial livestock include the Holstein, Ayrshire, Angus, and Limousin.

The term “poultry product”, as used herein, refers to any food that primarily contains poultry tissue, e.g. contains at least 70%, at least 80%, at least 90%, or at least 95% poultry tissue. The term “poultry” refers to any edible birds such as chickens, turkeys, ducks, geese, and squab. Poultry can include animals of the genus Gallus, for example the Gallus gallus domesticus, which is used as a food source for human consumption. Poultry can include animals of the genus Meleagris, for example the Meleagris gallopavo, which is used as a food source for human consumption.

The term “pork product”, as used herein, refers to any food product that primarily contains pig tissue, e.g. contains at least 70%, at least 80%, at least 90%, or at least 95% pig tissue. The term “pig” refers to any animal of the genus Sus, such as for example Sus Scrofa, which is used as a food source for human consumption. Exemplary pig breeds used as commercial livestock include Berkshire, Large White, Duroc, Hampshire, Landrace, Meishan, Pietrain, and many others.

As used herein, the term “fish product” should include any food product that primarily contains tissue from an aquatic animal, e.g. contains at least 70%, at least 80%, at least 90%, or at least 95% tissue from an aquatic animal. Aquatic animals can include lobster, crab, fresh water fish, smoked salmon, smoked other fish, salted fish, saltwater fish and other seafood.

As used herein, an “effective amount” is at least the minimum concentration or amount required to have a measurable decrease in one or more changes contributing to decreased shelf life of a food product including, but not limited to, water loss, oxidation, odor development, discoloration, or microbial changes such as the growth rate or concentration of one of more microorganisms that contribute to decreased shelf life of a food product.

The term “daily value”, as used herein, can be given the meaning supplied by the United States Food and Drug Administration (U.S. F.D.A.), for example as described in the “Guidance for Industry: A Food Labeling Guide” published by the Office of Nutrition, Labeling, and Dietary Supplements of the U.S. F.D.A., last revised January 2013. There are two sets of reference values for reporting nutrients in nutrition labeling: 1) Daily Reference Values (DRVs) and 2) Reference Daily Intakes (RDIs). These values assist consumers in interpreting information about the amount of a nutrient present in a food and in comparing nutritional values of food products. DRVs are provided for total fat, saturated fat, cholesterol, total carbohydrate, dietary fiber, sodium, potassium, and protein. RDIs are provided for vitamins and minerals and for protein for children less than four years of age and for pregnant and lactating women. To limit consumer confusion, the single term “daily value”, often denoted as “DV”, is used to designate both the DRVs and RDIs. For substances where no RDI or DRV has been established, the DV can be taken, for example, as the average daily intake of the substance based on food intake concentrations for persons over 2 years old on a standard 2,000-calorie diet.

The term “consumable salt”, as used herein, refers to derivatives of a compound, wherein the parent compound is modified by making acid or base salts thereof which are, within the scope of sound scientific judgment, suitable for consumption by human beings and animals without excessive toxicity, irritation, allergic response, or other problems or complications commensurate with a reasonable benefit/risk ratio. Example of consumable salts include but are not limited to mineral or organic acid salts of basic residues such as amines; and alkali or organic salts of acidic residues such as carboxylic acids. The consumable salts include the conventional non-toxic salts or the quaternary ammonium salts of the parent compound formed, for example, from non-toxic inorganic or organic acids. Such conventional non-toxic salts include those derived from inorganic acids such as hydrochloric, hydrobromic, sulfuric, sulfamic, phosphoric, and nitric acids; and the salts prepared from organic acids such as acetic, propionic, succinic, glycolic, stearic, lactic, malic, tartaric, citric, ascorbic, pamoic, maleic, hydroxymaleic, phenylacetic, glutamic, benzoic, salicylic, sulfanilic, 2-acetoxybenzoic, fumaric, tolunesulfonic, naphthalenesulfonic, methanesulfonic, ethane disulfonic, oxalic, and isethionic salts.

The consumable salts of the compounds can be synthesized from the parent compound, which contains a basic or acidic moiety, by conventional chemical methods. Such salts can be prepared by reacting the free acid or base forms of these compounds with a stoichiometric amount of the appropriate base or acid in water or in an organic solvent, or in a mixture of the two; generally, non-aqueous media like ether, ethyl acetate, ethanol, isopropanol, or acetonitrile are preferred. Lists of suitable salts can be found in Remington's Pharmaceutical Sciences, 20th ed., Lippincott Williams & Wilkins, Baltimore, Md., 2000, p. 704; and “Handbook of Pharmaceutical Salts: Properties, Selection, and Use,” P. Heinrich Stahl and Camille G. Wermuth, Eds., Wiley-VCH, Weinheim, 2002.

The term “generally recognized as safe” or “GRAS”, as used herein, refers to substances generally recognized, among qualified experts, as having been adequately shown to be safe under the conditions of its intended use, for example by general recognition of safety through scientific procedures under 21 C.F.R §170.30(b) or by general recognition of safety through experience based on common use in foods by a substantial history of consumption for food use under 21 C.F.R §170.30(c). GRAS substances can include those substances listed in 21 C.F.R. §182.

As used herein, the term “shelf life” refers to the period of time that a food product remains saleable to retail customers and remains fit and safe for use or consumption. Changes including, but not limited to, oxidation, odor development, discoloration in addition to microbial changes can alter the shelf life of the food product. In traditional meat processing, the shelf life of fresh meat and meat by-products is about 30 to 40 days after an animal has been slaughtered. Refrigeration of meat during this period of time largely arrests and/or retards the growth of micro-organisms. After about 30 to 40 days, however, refrigeration can no longer effectively control the proliferation of micro-organisms. Micro-organisms present on meat products after this time period may have proliferated to a great extent and/or have generated unacceptable levels of undesirable by-products. Spoilage micro-organisms may also act to discolor meat, making such meat unappealing and undesirable for human consumption. Pathogenic micro- organisms may have proliferated in this time period to a level wherein they can cause disease in an animal that consumes the food product.

“Food preservation”, as used herein, refers to methods which maintain or enhance food safety or palatability for example, by controlling the growth and proliferation of pathogenic and spoilage micro-organisms, thus guarding against food poisoning and delaying or preventing food spoilage, or by guarding against water loss, discoloration, or the development of unpleasant odors associated with food spoilage. Food preservation helps food remain safe and palatable for consumption for longer periods of time (i.e. improves the shelf life) and inhibits or prevents nutrient deterioration and/or organoleptic changes which cause food to become less palatable.

The term “micro-organism” as used herein, includes bacteria, fungi and parasites. Non-limiting examples of micro-organisms that can be controlled using the formulations and methods described herein include bacteria from the genus Aeromonas (e.g. A. hydrophilia), Arcobacter, Bacillus (e.g. B. cereus), Brochothrix (e.g. B. thermosphacta), Campylobacter (e.g. C. jejuni), Carnobacterium (e.g. C. piscicola), Chlostridium (e.g. C. perfringens, C botulinum), Enterobacteriacae, Escherichia (e.g. E. coli O157:H7), Listeria (e.g. L. monocytogenes), Pseudomonas (e.g. P. putida, P. fluorescens), Salmonella (e.g. S. Typhimurium), Serratia (e.g. S. liquefaciens), Shigella, Staphylococcus (e.g. S. aureus), Vibrio (e.g. V parahaemolyticus, V cholerae) and Yersina (e.g. Y. enterocolitica); fungi such as Aspergillus flavum and Penicillium chrysogenum; parasites such as Amoebiasis (Emoebiasis histolytica), Balantidiosis (Balantidiosis coli), Entamoeba histolytica, Cryptosporidiosis (e.g. Cryptosporidium parvum), Cyclosporidiosis (e.g. Cyclospora cayetanensis), Giardiasis (e.g. Giardia lamblia, Giardia intestinalis), Isosporiasis (Isosporiasis belli), Microsporidiosis (Enter ocytozoon bieneusi, S. intestinalis), Trichinella spiralis and Toxoplasma gondii. The term micro-organism also refers to vegetative or dormant forms of bacteria and fungi, such as spores wherein activation of the growth cycle may be controlled using the methods provided herein.

The term “spoilage micro-organism” as used herein refers to a micro-organism that acts to spoil food. Spoilage micro-organisms may grow and proliferate to such a degree that a food product is made unsuitable or undesirable for human or animal consumption. The production of undesirable by-products by the microorganism, such as carbon dioxide, methane, nitrogenous compounds, butyric acid, propionic acid, lactic acid, formic acid, sulfur compounds, and other gases and acids can cause detrimental effects on the foodstuff alteration of the color of meat surfaces to a brown, grey or green color, or creation of an undesirable odor. The color and odor alterations of food products due to the growth of spoilage micro-organisms frequently result in the product becoming unsaleable.

The term “pathogenic micro-organism” as used herein refers to a micro-organism capable of causing disease or illness in an animal or a human, for example, by the production of endotoxins, or by the presence of a threshold level of micro-organisms to cause food poisoning, or other undesirable physiological reactions in humans or animals.

### III. Mixtures and Compositions for Treating a Food Product

Dry mixtures for treating a food product are provided. The mixtures can be a dry powder mixture that can be added directly to the food product or can be combined with a suitable solvent to form a liquid composition. The mixtures can generally contain any number of components, e.g. 2, 3, 4, or more components. In some embodiments the mixture is a two-component mixture containing a soluble fiber and an insoluble fiber. For example, the mixture can contain psyllium husk and a citrus fiber. In other embodiments the mixture is a three-component mixture containing a soluble fiber, an insoluble fiber, and an ascorbic acid source. For example, the mixture can contain psyllium husk, a citrus fiber, and a citrus juice powder. In some embodiments the mixture can contain additional components, preferably components that do not impact the water retention or the rate of discoloration of the food product.

The mixture can contain a soluble fiber. The term “soluble fiber”, as used herein, refers to source of fiber that is “soluble” in water, e.g. at room temperature and a pH of about 7. When mixed with water a soluble fiber can form a gel-like substance and swell. The soluble fiber can come from a variety of fiber sources, for example psyllium husk, flax seed, xanthan gum, pectins, and combinations thereof. In preferred embodiments the soluble fiber is or includes psyllium husk. The soluble fiber, e.g. psyllium husk, can be present in an amount about 15%, 20%, 25%, 30%, 35%, 40%, 45%, 50%, or more (w/w) based upon the weight of the mixture. The soluble fiber, e.g. psyllium husk, can be present in an amount about 65%, 60%, 55%, 50%, 45%, 40%, 35%, 30%, 25%, 20% or less (w/w) based upon the weight of the mixture. In some embodiments the soluble fiber, e.g. psyllium husk, is present in an amount from 15% to 65% (w/w), from 20% to 60% (w/w), from 25% to 55% (w/w), or from 30% to 50% (w/w) based upon the weight of the mixture. The soluble fiber can generally have any particle size, for example from about 10 microns to 1000 microns. In some embodiments the soluble fiber has an average particle size that is about 10 microns, 25 microns, 50 microns, 100 microns, 200 microns, or more. In some embodiments the soluble fiber has an average particles size that is about 1000 microns, 800 microns, 600 microns, 500 microns, 400 microns, 300 microns, or less. The soluble fiber can be a soluble fiber that is generally recognized as safe for human consumption.

The mixture can contain an insoluble fiber. The term “insoluble fiber”, as used herein, refers to a source of fiber that does not generally absorb or retain water. The insoluble fiber can come from a variety of fiber sources, for example a citrus fiber, almond fiber, a cellulose, chia fiber, coconut fiber, corn fiber, cottonseed fiber, grape seed fiber, hemicelluloses, a lignin, oat fiber, rice hulls, safflower fiber, sesame fiber, soybean fiber, sunflower fiber, walnut fiber, and combinations thereof. In preferred embodiments the insoluble fiber is or includes a citrus fiber. The citrus fiber can be obtained from a citrus fruit such as an orange, a tangerine, a lime, a lemon, a grapefruit, or from a combination thereof The insoluble fiber, e.g. citrus fiber, can be present in an amount about 25%, 30%, 35%, 40%, 45%, 50%, 55%, 60%, or more (w/w) based upon the weight of the mixture. The insoluble fiber, e.g. citrus fiber, can be present in an amount about 85%, 80%, 75%, 70%, 65%, 60%, 55%, 50%, 45%, or less (w/w/) based upon the weight of the mixture. In some embodiments the insoluble fiber, e.g. citrus fiber, is present in an amount from 25% to 85% (w/w), from 30% to 80% (w/w), from 35% to 75% (w/w), or from 40% to 70% (w/w) based upon the weight of the mixture. The insoluble fiber can generally have any particle size, for example from about 10 microns to 1000 microns. In some embodiments the insoluble fiber has an average particle size that is about 10 microns, 25 microns, 50 microns, 100 microns, 200 microns, or more. In some embodiments the insoluble fiber has an average particles size that is about 1000 microns, 800 microns, 600 microns, 500 microns, 400 microns, 300 microns, or less. The insoluble fiber can be an insoluble fiber that is generally recognized as safe for human consumption.

The term “citrus fiber,” as used herein, refers to a fibrous component obtained from citrus pulp, citrus peel, citrus rag and combinations thereof. Citrus fiber is characterized by a high total dietary fiber content as well as a balanced ratio of soluble to insoluble dietary fiber. Although the citrus fiber can contain both soluble and insoluble fibers, as used herein the citrus fiber is considered an insoluble fiber source. Citrus fiber, particularly orange fiber, has a very high water binding capacity. Citrus fiber, as compared to citrus flour obtained from citrus peel, is lighter in color and relatively free of taste and odor. In contrast, citrus flour obtained from citrus peel is characterized by a citrus peel taste, odor and color, which can limit the product's uses. Additional advantages of citrus fiber include a higher total dietary fiber content (e.g., greater than about 70% versus 58%); lower carbohydrate content (e.g., about 5% versus 15%); and higher water binding capacity (e.g., greater than about 8 grams of water per gram of fiber versus 5.5 g/g). The protein content of the citrus fiber typically ranges from about 8 to 12 wt %.

The ratio of soluble to insoluble dietary fiber can be a factor in the citrus fiber's functionality. Preferably, the citrus fiber has a balanced ratio of soluble to insoluble dietary fiber. For example, the total dietary fiber preferably is made up of about 45-50% soluble dietary fiber and from 50-55% insoluble dietary fiber. Other considerations can include the degree of milling (granulometry) and drying conditions (process of drying). Generally, a higher degree of milling (i.e., a finer fiber granulometry) results in more smoothness of mouthfeel of the fiber in foods and beverages. Density and particle size may vary over a wide range depending on processing conditions. By way of example, density may range from about 80 to about 650 g/L, and average particle size may range from about 15 to about 600 microns. It should be understood that these ranges are merely exemplary. In some applications it may be desirable to employ significantly larger particle sizes, for example. In general, the citrus fiber may range from a very fine to a coarse powder structure.

The mixture can contain an ascorbic acid source. Sources of ascorbic acid can generally include any source of ascorbic acid, although in preferred embodiments the ascorbic acid source includes those sources derived from foods high in ascorbic acid and generally recognized as safe for human consumption. The ascorbic acid source can be derived from a citrus fruit, e.g. can be a citrus juice powder. The citrus juice powder can be an orange juice powder, a tangerine juice powder, a lime juice powder, a lemon juice powder, a grapefruit juice powder, or a combination thereof The ascorbic acid source can be a non-citrus ascorbic acid source such as chili powder, red bell pepper powder, green bell pepper powder, kale powder, broccoli powder, papaya powder, strawberry powder, cauliflower powder, pineapple powder, kiwi powder, mango powder, acerola juice concentrate or powder, kakadu plum juice concentrate or powder, camu camu powder, or a combination thereof The ascorbic acid source, e.g. citrus juice powder, can be present in an amount about 0.1%, 0.5%, 1%, 1.5%, 2%, 2.5%, 3%, or more (w/w) based upon the weight of the mixture. The ascorbic acid source, e.g. citrus juice powder, can be present in an amount about 35%, 30%, 25%, 20%, 18%, 16%, 14%, 12%, 10%, 8%, or less (w/w) based upon the weight of the mixture. In some embodiments the ascorbic acid source, e.g. citrus juice powder, is present in an amount from 0.5% to 35% (w/w), from 1% to 30% (w/w/), from 1% to 20% (w/w), or from 1% to 10% (w/w) based upon the weight of the mixture. The ascorbic acid source can generally have any particle size, for example from about 10 microns to 1000 microns. In some embodiments the ascorbic acid source has an average particle size that is about 10 microns, 25 microns, 50 microns, 100 microns, 200 microns, or more. In some embodiments the ascorbic acid source has an average particles size that is about 1000 microns, 800 microns, 600 microns, 500 microns, 400 microns, 300 microns, or less.

The mixture can have a high water-binding capacity, for example to aid in the retention of water or to improve the water holding capacity of the food product. The water-binding capacity, as used herein, refers to the ability of a material to retain or absorb water relative to the dried material. The water-binding capacity can be measured by a variety of methods, for example gravimetrically based on the difference between the mass of the dried mixture and the equilibrated mass of the mixture upon exposure to water vapor of a known relative humidity, e.g. about 80%, 84%, 88%, 92% relative humidity or more. The mixture can have a water-binding capacity of about 5 g, 10 g, 15 g, 20 g, 30 g, 40 g, 50 g, or more per gram of mixture. The mixture can have a water-binding capacity that is about 1:1-100:1, 1:1-50:1, 5:1-50:1, or 5:1-15:1 (wet mass : dry mass). In some embodiments the mixture has a water-binding capacity that is greater than the additive water-binding capacity of the components in the mixture, e.g. the mixture has a water-binding capacity that is at least about 10%, 15%, 20%, or more greater than the sum of the water-binding capacities of the components in the mixture. The density of the mixture can depend on a variety of factors including the identity and percentages of the components in the mixture as well as the amount of processing or milling of the components.

Liquid compositions for treating a food product are also provided. The liquid compositions can contain any of the mixtures described herein and a suitable solvent. The solvent can be an edible liquid such as water, a water-based liquid, a water miscible liquid, or a combination thereof The solvent can be generally recognized as safe for human consumption. The liquid composition can be a solution, a suspension, or a colloid.

The liquid composition can generally contain any amount of the mixture to be effective for treating the food product. The liquid composition can contain an effective amount to improve the water holding capacity (WHC), to decrease discoloration, or to decrease unpleasant odors of the food product upon treatment. In some embodiments the liquid composition contains about 1% (w/w) of the mixture based upon the weight of the liquid composition, e.g. about 1 pound of mix per 99 pounds of water. The liquid composition can contain about 10%, 8%, 6%, 5%, 4%, 3%, 2%, 1.5,%, 1%, or less of the mixture (w/w) based upon the weight of the liquid composition. The liquid composition can generally contain any amount of the mixture to be effective for treating the food product. The effective amount of the mixture can be effective to provide the food product with about 1%, 3%, 5%, 10%, 15%, 20%, or greater water retention for a period of about 12 hours, 18 hours, 24 hours, 36 hours, 48 hours, 72 hours, or more when applied to the food product. The effective amount of the mixture can be effective to provide the food product with about 1%, 3%, 5%, 10%, 15%, 20%, or greater water retention upon cooking when applied to the food product prior to cooking.

### IV. Methods of Treating a Food Product

Methods of treating a food product are also provided. The methods can be used to increase the shelf life of the food product, for example by increasing the water holding capacity or decreasing the discoloration of the food product upon treatment. The methods can include applying an effective amount of one of the mixtures provided herein to the food product to increase the shelf life, e.g. to increase the water holding capacity or decrease the discoloration. The methods can include applying an effective amount of one of the liquid compositions provided herein to the food product to increase the shelf life, e.g. to increase the water holding capacity or decrease the discoloration.

The methods can include applying an effective amount of one of the mixtures provided herein to the food product to increase the water retention of the food product. The effective amount of the mixture can be effective to provide the food product with about 1%, 3%, 5%, 10%, 15%, 20%, or greater water retention for a period of about 12 hours, 18 hours, 24 hours, 36 hours, 48 hours, 72 hours, or more when applied to the food product. The effective amount of the mixture can be effective to provide the food product with about 1%, 3%, 5%, 10%, 15%, 20%, or greater water retention upon cooking when applied to the food product prior to cooking.

The methods can generally include any method of mixing, coating, injecting, or otherwise applying the mixtures and liquid compositions provided herein to a food product. In some embodiments the food product is a ground meat product such as ground turkey, ground beef, or ground pork, and the method includes mixing the mixture or the liquid composition with the ground meat product. In some embodiments the food product can be vacuum tumbled with an effective amount of a mixture or liquid composition provided herein.

### V. Treated Food Products

Treated food products are provided. The food product can contain a meat product and an effective amount of a mixture or liquid composition provided herein. The food product can be generally any food product where increasing water holding capacity and/or decreasing discoloration are desired to increase the shelf life. For example, the food product can be of beef, poultry, pork, fish, or a combination thereof The food product can be a ready-to-eat food product or can be manufactured for cooking prior to consumption.

The treated food product can be more palatable for consumers because the food product has improved water holding capacity and/or decreased discoloration compared to the food product without the mixture or liquid composition added.

The food product can contain an effective amount of the mixture or liquid composition such that the food product has increased water holding capacity as compared to the otherwise same food product without the mixture or liquid composition. The “water holding capacity”, as used herein, refers to the ability of the food product to hold water over a period of time, upon storage, or upon cooking. The water holding capacity can be measured in a variety of ways known in the art. The water holding capacity can be measured, for example, using a method described in Trout, Meat Sci., 1988, 23(4):235-252, the contents of which are incorporated herein in their entirety. The water holding capacity can be measured by gravimetric water loss (drip loss) over a period of time, the amount of water (squeezable water) lost upon compression of the food product between parallel plates, centrifugation, or cooking loss. The treated food product can have a water holding capacity that is at least 20%, 30%, 40%, 50%, 75%, 100%, 150%, or more greater than the water holding capacity of the otherwise same food product but without the addition of the mixture or liquid composition. The food product can retain the water holding capacity over a period of time. For example, the food product can retain at least about 75%, 80%, 85%, 90%, 95%, 98%, or more of the water for a period of about 12 hours, 18 hours, 24 hours, 2 days, 3 days, 4 days, 6 days, 8 days, 10 days, or more as compared to the initial food product upon treatment. The food product can retain the water holding capacity upon cooking. For example, the food product can retain at least about 50%, 60%, 70%, 80%, or more of the water upon cooking the food product as compared to the initial food product upon treatment. The food product can have about 1%, 3%, 5%, 10%, 15%, 20%, or greater water retention for a period of about 12 hours, 18 hours, 24 hours, 36 hours, 48 hours, 72 hours, or more. The food product can have about 1%, 3%, 5%, 10%, 15%, 20%, or greater water retention upon cooking. The food product can contain an effective amount of the mixture or liquid composition such that the food product has decreased discoloration as compared to the otherwise same food product without the mixture or liquid composition. The color or the discoloration of the food product can be measured in a variety of methods known to those skilled in the relevant art. The methods can include measuring the color with a reflectance colorimeter. The methods can include measuring the L*, a*, b* color scale for the food product. The food product can retain the color of the food product over a period of time. For example, the food product can retain at least about 70%, 75%, 80%, 85%, 90%, 95%, 98%, or more of the color for a period of about 12 hours, 18 hours, 24 hours, 2 days, 3 days, 4 days, 6 days, 7 days, 8 days, 10 days, or more under typical safe storage conditions.

We claim:

1. A dry mixture for treating a food product, the mixture comprising:
a soluble fiber present in an amount from 20% to 60% (w/w) based upon the weight of the mixture; and
an insoluble fiber present in an amount from 30% to 80% (w/w) based upon the weight of the mixture.

2. The mixture of claim 1, further comprising an ascorbic acid source present in an amount from 1% to 30% (w/w) based upon the weight of the mixture.

3. The mixture of claim 1, the composition consisting essentially of the soluble fiber and the insoluble fiber.

4. The mixture of claim 2, the composition consisting essentially of the soluble fiber, the insoluble fiber, and the ascorbic acid source.

5. The mixture of claim 1, wherein the soluble fiber is selected from the group consisting of psyllium husk, flax seed, xanthan gum, a pectin, and a combination thereof.

6. The mixture of claim 1, wherein the insoluble fiber is selected from the group consisting of a citrus fiber, almond fiber, a cellulose, chia fiber, coconut fiber, corn fiber, cottonseed fiber, grape seed fiber, hemicelluloses, a lignin, oat fiber, rice hulls, safflower fiber, sesame fiber, soybean fiber, sunflower fiber, walnut fiber, and a combination thereof.

7. The mixture of claim 1, wherein the insoluble fiber is a citrus fiber obtained from a citrus fruit selected from the group consisting of an orange, a tangerine, a lime, a lemon, a grapefruit, and a combination thereof.

8. The mixture of claim 1, wherein the soluble fiber is psyllium husk and the insoluble fiber is a citrus fiber.

9. The mixture of claim 2, wherein the ascorbic acid source is a citrus juice powder.

10. The mixture of claim 9, wherein the citrus juice powder is selected from the group consisting of a orange juice powder, a tangerine juice powder, a lime juice powder, a lemon juice powder, a grapefruit juice powder, and a combination thereof.

11. The mixture of claim 2, wherein the ascorbic acid source is a non-citrus source selected from the group consisting of chili powder, red bell pepper powder, green bell pepper powder, kale powder, broccoli powder, papaya powder, strawberry powder, cauliflower powder, pineapple powder, kiwi powder, mango powder, acerola juice concentrate or powder, kakadu plum juice concentrate or powder, camu camu powder, and a combination thereof.

12. The mixture of claim 1, wherein the mixture has a water binding capacity of about 5 grams to 15 grams of water per gram of mixture.

13. The mixture of claim 1, wherein one or both of the soluble fiber and the insoluble fiber have an average particle size from about 50 microns to 300 microns.

14. The mixture of claim 1, wherein the food product is a ready-to-eat food product.

15. The mixture of claim 1, wherein the food product is selected from the group consisting of beef, poultry, pork, fish, and a combination thereof.

16. A liquid composition for treating a food product, the composition comprising an effective amount of the mixture of claim 1 and a suitable solvent.

17. The liquid composition of claim 16 comprising about 5% (w/w) or less of the mixture based upon the weight of the composition.

18. The liquid composition of claim 16, wherein the effective amount is effective to provide the food product with at least 3% water retention for a period of at least 24 hours when applied to the food product.

19. The liquid composition of claim 16, wherein the effective amount is effective to provide the food product with at least 3% water retention upon cooking when applied to the food product prior to cooking.

20. The liquid composition of claim 16, wherein the effective amount is effective to provide the food product with at least 80% color retention for a period of at least one week under standard storage conditions when applied to the food product prior to storage.

21. The liquid composition of claim 16, wherein the solvent is an edible liquid selected from the group consisting of water, a water-based liquid, a water miscible liquid, and a combination thereof.

22. A method of treating a food product, the method comprising the step of applying an effective amount of the mixture of claim 1 to the food product.

23. The method of claim 22, wherein the food product is a ready-to-eat food product.

24. The method of claim 22, wherein the food product is selected from the group consisting of beef, poultry, pork, fish, and a combination thereof.

25. The method of claim 22, wherein the effective amount is effective to provide the food product with at least 3% water retention for a period of at least 24 hours.

26. The method of claim 22, wherein the effective amount is effective to provide the food product with at least 3% water retention upon cooking.

27. The method of claim 22, wherein the effective amount is effective to provide the food product with at least 80% color retention for a period of at least one week under standard storage conditions.

28. The method of claim 22, wherein the food product is a ground meat product and the mixture or liquid composition is mixed with the food product.

29. The method of claim 22, wherein the liquid composition is injected into the food product.

30. The method of claim 22, wherein the mixture or liquid composition is vacuum tumbled with the food product.

31. A food product comprising a meat product and an effective amount of the mixture of claim 1.

32. The food product of claim 31, wherein the food product is a ready-to-eat food product.

33. The food product of claim 31, wherein the meat product is selected from the group consisting of beef, poultry, pork, fish, and a combination thereof.

34. The food product of claim 31, wherein the food product has at least 3% water retention for a period of at least 24 hours.

35. The food product of claim 31, wherein the food product has at least 3% water retention upon cooking.

36. The food product of claim 31, wherein the food product has at least 80% color retention for a period of at least one week under standard storage conditions.
